(19) United States
(12) Patent Application Publication
(10) Pub. No.: US 2020/0368846 A1
(43) Pub. Date: Nov. 26, 2020

(54) LASER PROCESSING METHOD FOR LONG FILM

(71) Applicant: NITTO DENKO CORPORATION, Ibaraki-shi, Osaka (JP)

(72) Inventor: Naoyuki Matsuo, Ibaraki-shi (JP)

(73) Assignee: NITTO DENKO CORPORATION, Ibaraki-shi, Osaka (JP)

(21) Appl. No.: 16/768,163

(22) PCT Filed: Nov. 27, 2018
(86) PCT No.: PCT/JP2018/043530

§ 371 Date: May 29, 2020

(30) Foreign Application Priority Data
Nov. 30, 2017 (JP) 2017-229846

(51) Int. Cl. B23K 26/082; B23K 26/38

(52) U.S. Cl. CPC B23K 26/082; B23K 26/0643; B23K 26/38

(57) ABSTRACT

A laser processing method for a long film is disclosed which has high productivity. A laser processing method according to the present invention includes a process of cutting a long film F by irradiating the long film F with a laser beam L while scanning the laser beam L by a deflecting operation of a galvanometer scanner 13 and while continuously conveying the long film F in the longitudinal direction. The control device 3 controls the deflecting operation of the galvanometer scanner 13 based on a desired cutting shape of the long film F set in advance and a conveying speed of the long film F that is calculated using a rotary encoder 2.

### TECHNICAL FIELD

The present invention relates to a laser processing method for cutting a long film such as an optical film using a laser beam. In particular, the present invention relates to a laser processing method for a long film which has high productivity.

### BACKGROUND ART

In recent years, optical films such as a polarizing film are used not only for televisions and personal computers, but also for diverse display uses such as smartphones, smartwatches and vehicle-mounted displays.

Therefore, the shapes required for optical films are becoming complex and free-form, and high dimensional accuracy is also required. There are similar needs for various kinds of films other than optical films also.

Known methods for irregular shape processing for cutting into various shapes other than rectangles include end milling, punching, profile milling and laser processing.

Among these various irregular shape processing methods, a laser processing method has the excellent advantages of easily corresponding to cutting of shapes that are complex and free form, and also easily obtaining high dimensional accuracy as well as being excellent in processing quality.

As a laser processing method for a film, for example, it is conceivable to place a sheet-like film on an X-Y dual-axis stage and fix the film to the X-Y dual-axis stage by suction, and then drive the X-Y dual-axis stage to change the relative position on a X-Y two-dimensional plane of the film with respect to a laser beam. Further, it is also conceivable to change the position on an X-Y two-dimensional plane of a laser beam with which a sheet-like film is irradiated by fixing the position of the film and deflecting the laser beam that is oscillated from a laser beam source using a galvanometer scanner or a polygon scanner. It is also conceivable to combine use of both the aforementioned scanning of a film using an X-Y dual-axis stage and scanning of a laser beam using a galvanometer scanner or the like.

However, in the case of a laser processing method that uses a sheet-like film as described above, time is required to place the film at a predetermined position on an X-Y dual-axis stage, and time is required to take the film off the X-Y dual-axis stage to retrieve the film after laser processing. Furthermore, time is also required to fix the sheet-like film to the X-Y dual-axis stage by suction, and to release the fixing by suction of the sheet-like film. Consequently, sufficiently high productivity is not obtained.

To increase productivity, it is also conceivable to use a long film that is wound in a roll shape and not to use a sheet-like film as described above, and to change the position on an X-Y two-dimensional plane of a laser beam with which the long film is irradiated, by conveying the long film by means of a so-called “roll-to-roll system” and deflecting the laser beam which is oscillated from a laser beam source by using a galvanometer scanner or the like.

For example, a method disclosed in Patent Literature 1 has been proposed as a laser processing method for a long film that uses a roll-to-roll system.

According to the method disclosed in Patent Literature 1, a predetermined area of a long film (work 40) is conveyed to a suction position of a processing table 20 by a work conveying apparatus 30 and is fixed by suction to the processing table 20, and thereafter laser processing of the long film is performed using a galvanometer scanner 15. When the laser processing is completed, fixing by suction of the predetermined area of the long film to the processing table 20 is released, and the next area is conveyed to the suction position of the processing table 20 by the work conveying apparatus 30 and the same operation as described above is performed (paragraph 0034 and FIG. 1 and the like in Patent Literature 1).

In other words, the method disclosed in Patent Literature 1 is a method in which intermittent conveyance that alternately repeats conveying and stopping of a long film is performed, and the long film is fixed by suction at a stopping position and laser processing is performed using a galvanometer scanner.

According to the method disclosed in Patent Literature 1, in comparison to a case of using a sheet-like film, in addition to time not being required to place the film on an X-Y dual-axis stage and take the film off therefrom, a laser beam is scanned by means of a galvanometer scanner and not by scanning the laser beam by means of an X-Y dual-axis stage, and consequently the time required for laser processing is shortened and productivity can be increased.

However, in the method disclosed in Patent Literature 1, because intermittent conveyance is used that alternately repeats conveying and stopping of a long film, conveying of the long film requires more time in comparison to a case of continuously conveying a long film without stopping the film. Further, the point that time is required for fixing the long film by suction and time is also required for releasing the fixing by suction of the long film is the same as in the aforementioned case of using a sheet-like film.

Therefore, a laser processing method which has even higher productivity is desired.

### CITATION LIST

### Patent Literature

[Patent Literature 1] JP2011-31248A

### SUMMARY OF INVENTION

### Technical Problem

The present invention has been made to solve the problem of the prior art that is described above, and an object of the present invention is to provide a laser processing method for a long film which has high productivity.

### Solution to Problem

As the result of intensive studies conducted by the present inventors to solve the aforementioned problem, the present inventors discovered that in the case of conveying a long film by means of a roll-to-roll system, for example, by setting the tensile force of the long film between conveying rolls to a certain magnitude or more, even if the long film is not fixed by suction, laser processing can be performing without impairing the dimensional accuracy of the cutting shape. If fixing by suction is not required, it is possible to continuously convey a long film without stopping when performing laser processing. The present inventors focused their attention on the fact that in the case of continuously conveying a long film, by using the conveying speed of the long film, it is possible to control a deflecting operation of a galvanometer scanner so that a desired cutting shape of the long film is obtained, and thereby completed the present invention.

That is, to solve the aforementioned problem, the present invention provides a laser processing method for a long film, comprising: a process of cutting a long film by irradiating the long film with a laser beam while scanning the laser beam by a deflecting operation of a galvanometer scanner and while continuously conveying the long film in a longitudinal direction, wherein the deflecting operation of the galvanometer scanner is controlled based on a desired cutting shape of the long film set in advance and a conveying speed of the long film.

In a case where a long film is stopped, it suffices to merely control a deflecting operation of a galvanometer scanner so that the desired cutting shape of the long film is obtained (so that a laser beam is scanned at the desired cutting positions). In contrast, in a case where a long film is being conveyed, simultaneously with the laser beam being scanned by the deflecting operation of the galvanometer scanner, the position of the long film changes according to the conveying speed. In other words, the scanning position of the laser beam on the long film will be determined according to a resultant speed of the scanning speed of the laser beam by the deflecting operation of the galvanometer scanner and the conveying speed of the long film.

According to the present invention, a deflecting operation of the galvanometer scanner is controlled based on the desired cutting shape of the long film set in advance and the conveying speed of the long film. In other words, the deflecting operation of the galvanometer scanner is controlled so that scanning positions of the laser beam on the long film that are determined by the resultant speed of the scanning speed of the laser beam by the deflecting operation of the galvanometer scanner and the conveying speed of the long film match the desired cutting shape (desired cutting positions) of the long film. Therefore, it is possible to cut a long film into a desired cutting shape while continuously conveying the long film in the longitudinal direction.

According to the present invention, since a long film is continuously conveyed without being stopped during laser processing, the time required for conveying the long film is shortened. Further, no time is required for fixing the long film by suction or for releasing the long film fixed by suction. It is therefore possible to increase the productivity of laser processing of the long film.

In the present invention, it is possible to use a setting value set in advance, as the conveying speed of the long film.

However, preferably a conveying speed of the long film is measured, and the deflecting operation of the galvanometer scanner is controlled based on the desired cutting shape of the long film and the measured conveying speed of the long film.

According to the preferable method described above, because the deflecting operation of the galvanometer scanner is controlled using the actually measured conveying speed of the long film, in comparison to a case in which a setting value of the conveying speed is used, the scanning positions of the laser beam on the long film more accurately match the desired cutting shape (desired cutting positions) of the long film, and an increase in the dimensional accuracy of the cutting shape can be expected. In other words, because the actual conveying speed can fluctuate relative to a setting value, cutting with high dimensional accuracy is enabled that takes into consideration error amounts that arise due to fluctuations.

### Advantageous Effect of Invention

According to the present invention, it is possible to increase the productivity of laser processing of a long film.

### BRIEF DESCRIPTION OF DRAWINGS

FIG. 1 is a perspective view that schematically illustrates an example of an arrangement state of a laser processing apparatus that is used in a laser processing method according to one embodiment of the present invention.

FIG. 2 is a plan view that schematically illustrates an internal configuration of an optical unit of the laser processing apparatus illustrated in FIG. 1.

FIG. 3 is views that illustrate outline flows of a single cycle of laser processing methods according to an Example, Comparative Examples and a Reference Example.

FIG. 4 is a table showing results of evaluating the cycle times of the laser processing methods according to the Example, the Comparative Examples and the Reference Example.

### DESCRIPTION OF EMBODIMENT

Hereunder, a laser processing method for a long film according to one embodiment of the present invention is described with reference being made as appropriate to the attached drawings.

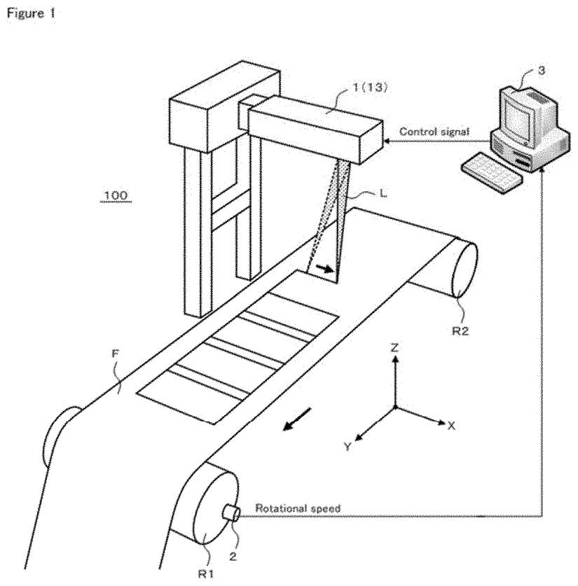

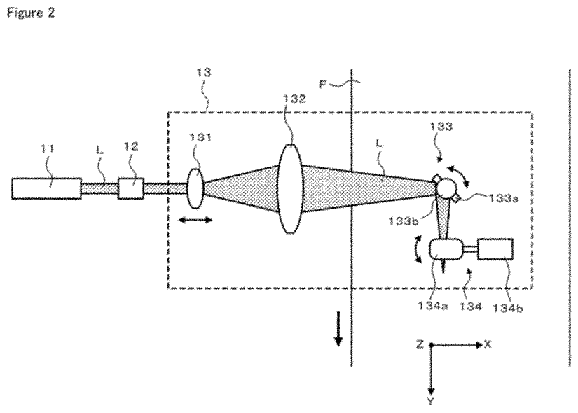

FIG. 1 is a perspective view that schematically illustrates an example of an arrangement state of a laser processing apparatus used in a laser processing method according to one embodiment of the present invention. FIG. 2 is a plan view that schematically illustrates an internal configuration of an optical unit of the laser processing apparatus illustrated in FIG. 1. Note that, in FIG. 1 and FIG. 2, an arrow mark X represents a width direction of a long film F (direction orthogonal to a longitudinal direction in a plane of the long film F), an arrow mark Y represents the longitudinal direction of the long film F (conveyance direction), and an arrow mark Z represents a direction of the normal line to the long film F.

As illustrated in FIG. 1, a laser processing apparatus 100 of the present embodiment includes an optical unit 1, a rotary encoder 2 and a control device 3.

As illustrated in FIG. 2, the optical unit 1 includes a laser beam source 11, an optical element 12 and a galvanometer scanner 13. Specifically the laser beam source 11, the optical element 12 and the galvanometer scanner 13 are contained inside a housing of the optical unit 1 illustrated in FIG. 1.

For example, a laser beam source that pulses a laser beam L having a wavelength in the infrared region is used as the laser beam source 11. Preferably, a CO laser beam source (oscillation wavelength: 5 μm) or a CO₂ laser beam source (oscillation wavelength: 9.3 to 10.6 μm) is used for which the wavelength of the laser beam L that is pulsed from the laser beam source 11 is 5 μm or more and 11 μm or less. In the case of using a CO laser beam source, an optical path of the laser beam L may be purged using an inert gas such as nitrogen.

The optical element 12 is constituted by various optical components such as an acousto-optic modulator (AOM) for controlling the power (intensity) of the laser beam L, an expander for adjusting the beam size of the laser beam L, and a homogenizer for flattening the spatial beam profile of the laser beam L.

The laser beam L that is oscillated from the laser beam source 11 and passes through the optical element 12 is reflected and deflected by the galvanometer scanner 13 and impinges onto the long film F. Specifically, an opening (not illustrated) is provided in the undersurface of the housing of the optical unit 1 illustrated in FIG. 1, and the laser beam L reflected and deflected by the galvanometer scanner 13 is impinges onto the long film F through the aforementioned opening.

The galvanometer scanner 13 of the present embodiment includes a movable lens 131, a condenser lens 132, a first galvanometer mirror 133 and a second galvanometer mirror 134.

The movable lens 131 is a lens capable of changing position in the optical axis direction of the laser beam L (in the example illustrated in FIG. 2, the X-direction that is the width direction of the long film F). When the movable lens 131 changes position, the focal position of the laser beam L that is condensed by the condenser lens 132 changes.

The first galvanometer mirror 133 includes a mirror part 133a and a galvanometer motor 133b. The mirror part 133a pivots about the direction of the normal line (Z direction) to the long film F by means of the galvanometer motor 133b. The second galvanometer mirror 134 includes a mirror part 134a and a galvanometer motor 134b. The mirror part 134a pivots about the width direction (X-direction) of the long film F by means of the galvanometer motor 134b.

After the laser beam L incident on the galvanometer scanner 13 passes through the movable lens 131 and the condenser lens 132, the laser beam L is reflected and deflected in sequence at the mirror part 133a of the first galvanometer mirror 133 and the mirror part 134a of the second galvanometer mirror 134 and impinges onto the long film F. Because the mirror part 133a of the first galvanometer mirror 133 and the mirror part 134a of the second galvanometer mirror 134 pivot as mentioned above, the deflection direction of the laser beam L successively changes according to the pivot angles of the mirror part 133a and the mirror part 134a, and the laser beam L is thus scanned on the long film F (on an X-Y two-dimensional plane formed from the width direction (X-direction) and the longitudinal direction (Y-direction) of the long film F). At such time, the movable lens 131 is controlled so as to change position according to the pivot angles of the mirror part 133a and the mirror part 134a so that the spot diameter of the laser beam L is a uniform diameter at each of the scanning positions of the laser beam L.

If the irradiation direction of the laser beam L that is scanned and emitted to the long film F by the galvanometer scanner 13 deviates from the direction of the normal line to the long film F (if the laser beam L is emitted at an angle relative to the direction of the normal line to the long film F), the cut end face of the long film F will be a tapered shape. In order to suppress the occurrence of a situation in which the cut end face becomes an excessively tapered shape, it is preferable to control the deflecting operation of the galvanometer scanner 13 so that the angle of incidence of the laser beam L (angle formed between the irradiation direction of the laser beam L and the direction of the normal line to the long film F) becomes 20° or less, and further preferably is made 15° or less.

Note that, it is also possible to use a commercially available apparatus such as, for example, “3D Galvanometer Scanner” manufactured by Raylase GmbH, “Laser Scanning System” manufactured by Scanlab GmbH, “Galvanometer Scanner System” manufactured by Y-E Data Inc., or “Galvanometer Scanner System” manufactured by Arges GmbH as the galvanometer scanner 13 which is equipped with the movable lens 131, the condenser lens 132, the first galvanometer mirror 133 and the second galvanometer mirror 134 as in the present embodiment.

Furthermore, it is also possible to use a galvanometer scanner which is equipped with the condenser lens 132, the first galvanometer mirror 133 and the second galvanometer mirror 134 (and which is not equipped with the movable lens 131) instead of the galvanometer scanner 13 of the present embodiment. It is possible to use a commercially available apparatus such as, for example, “2D Galvanometer Scanner” manufactured by Raylase GmbH, as the aforementioned galvanometer scanner. In the case of using a galvanometer scanner which is not equipped with the movable lens 131, preferably a telecentric fθ lens is disposed along the optical path of the laser beam L between the galvanometer scanner and the long film F. The laser beam L incident from the galvanometer scanner which is not equipped with the movable lens 131 and exits from the telecentric fθ lens will impinge onto the long film F from the direction of the normal line to the long film F at each of the scanning positions on the long film F, and will also impinge with a uniform spot diameter at each of the scanning positions.

In a case where the dimension in the width direction (X-direction) of the long film is small (for example, the dimension in the width direction is ≤60 mm), it is preferable to use a galvanometer scanner which is not equipped with the movable lens 131, and a telecentric fθ lens. The reason is that, since the long film F will be irradiated with the laser beam from the direction of the normal line to the long film F at each of the scanning positions, fluctuations in the spot diameter (spot diameter along the surface of the long film F) will not arise due to irradiation that is inclined relative to the direction of the normal line. On the other hand, in a case where the dimension in the width direction (X-direction) of the long film is large (for example, the dimension in the width direction is >60 mm), since use of a telecentric fθ lens will not be practical, it is preferable to use the galvanometer scanner 13 equipped with the movable lens 131 as in the present embodiment. In a case where long films F whose width direction dimensions differ significantly from each other are to be conveyed on the same conveyance line, it is also conceivable to provide both a laser processing apparatus that uses a telecentric fθ lens and a galvanometer scanner without the movable lens 131, and the laser processing apparatus 100 that uses the galvanometer scanner 13 equipped with the movable lens 131 as in the present embodiment.

The rotary encoder 2 is, for example, attached to a rotary shaft of a conveying roll R1 that conveys the long film F, and detects the rotational position of the conveying roll R1 and successively outputs the detected rotational position to the control device 3.

The control device 3 controls the deflecting operation of the galvanometer scanner 13. Specifically, the desired cutting shape of the long film F is input in advance to the control device 3. Further, as mentioned above, the rotational position of the conveying roll R1 is successively input to the control device 3, and the control device 3 calculates the peripheral speed of the conveying roll R1 by means of the rotational speed that is calculated based on the rotational positions that are input and the diameter of the conveying roll R1, and treats the calculated peripheral speed of the conveying roll R1 as the conveying speed of the long film F. The control device 3 controls the deflecting operation of the galvanometer scanner 13 based on the input desired cutting shape of the long film F and the calculated conveying speed of the long film F. Specifically, the control device 3 controls the deflecting operation of the galvanometer scanner 13 so that the scanning positions of the laser beam L on the long film F that are determined based on the resultant speed of the scanning speed of the laser beam L which is scanned by the deflecting operation of the galvanometer scanner 13 and the conveying speed of the long film F match the desired cutting shape of the long film F (desired cutting positions). The control device 3 outputs a control signal for performing the aforementioned control to the galvanometer motor 133b of the first galvanometer mirror 133 and the galvanometer motor 134b of the second galvanometer mirror 134. Further, the control device 3 outputs a control signal for causing the movable lens 131 to change position in accordance with the pivot angles of the mirror part 133a and the mirror part 134a to a drive mechanism (not illustrated) for causing the movable lens 131 to change position, so that the spot diameter of the laser beam L is a uniform diameter at each of the scanning positions of the laser beam L.

Further, the control device 3 outputs a control signal to the laser beam source 11 to control settings with respect to the on/off timing, repetition frequency, and power of the laser beam L that is oscillated from the laser beam source 11.

A laser processing method according to the present embodiment that uses the laser processing apparatus 100 having the above configuration is described hereunder.

As illustrated in FIG. 1, the laser processing method according to the present embodiment includes a process of cutting the long film F by irradiating the long film F with the laser beam L while scanning the laser beam L by means of a deflecting operation of the galvanometer scanner 13 and while continuously conveying the long film F in the longitudinal direction (Y-direction) between the conveying rolls R1 and R2. At such time, in order to make the tensile force of the long film F between the conveying rolls R1 and R2 a certain magnitude or more, it is preferable to set the rotational speed of the conveying roll R1 located on the downstream side in the conveyance direction to be somewhat higher than the rotational speed of the conveying roll R2 located on the upstream side in the conveyance direction. Further, to suppress the occurrence of a disturbance such as flapping during conveyance of the long film F and thereby perform stable cutting, a suction device for sucking the long film F to an extent to which continuous conveyance is possible may be provided. Further, at such time, the control device 3 controls the deflecting operation of the galvanometer scanner 13 based on the desired cutting shape of the long film F set in advance and the conveying speed of the long film F (in the present embodiment, a conveying speed calculated using a rotational position detected by the rotary encoder 2). The cutting form with respect to the long film F is not limited to a full cut, and it is also possible to adopt a half cut as the cutting form.

Examples of the long film F that is the cutting object in the laser processing method according to the present include a plastic film. Examples of the plastic film include a single-layer film or a laminated film composed of multiple layers which is formed of polyethylene terephthalate (PET), polyethylene (PE), polypropylene (PP), an acrylic resin such as polymethyl methacrylate (PMMA), a cyclic olefin polymer (COP), a cyclic olefin copolymer (COC), a polycarbonate (PC), a urethane resin, a polyvinyl alcohol (PVA), a polyimide (PI), polytetrafluoroethylene (PTFE), polyvinyl chloride (PVC), polystyrene (PS), triacetylcellulose (TAC), polyethylene naphthalate (PEN), ethylene vinyl acetate (EVA), a polyamide (PA), a silicone resin, an epoxy resin, a liquid crystal polymer, or a plastic material such as various kinds of resin foam.

The long film F adopted as the cutting object in the laser processing method according to the present embodiment preferably has an absorptivity of 15% or more with respect to the wavelength of the laser beam L with which it is irradiated.

In a case where the plastic film is a laminated film composed of multiple layers, various kinds of adhesive such as acrylic adhesive, urethane adhesive, or silicone adhesive, or a bonding agent may be interposed between the layers.

Further, an electroconductive inorganic membrane composed of indium tin oxide (ITO), Ag, Au, or Cu or the like may be formed on the surface of the plastic film.

The laser processing method according to the present embodiment is favorably used for various kinds of optical films such as a polarizing film or a phase contrast film to be particularly used in a display.

The thickness of the long film F is preferably made to fall within the range of 20 to 500 μm.

In the laser processing method according to the present embodiment, the control device 3 controls the galvanometer scanner 13 so that a shot pitch of the laser beam L is smaller than the spot diameter on the long film F of the laser beam L. The shot pitch is a value obtained by dividing the scanning speed of the laser beam L (relative movement speed between the laser beam L and the long film F) by the repetition frequency (equivalent to the number of pulses of the oscillated laser beam L per unit time), and means the interval between a laser beam L emitted by a certain pulsing and a laser beam L emitted by the next pulsing.

Note that, in the laser processing method according to the present embodiment, there is also a possibility that, when the long film F is conveyed in the longitudinal direction (Y-direction) between the conveying rolls R1 and R2, the long film F will zigzag in the width direction (X-direction). To suppress the influence of such zigzagging, it suffices to provide a sensor that detects an edge of the long film F (for example, an optical or ultrasound sensor), and to successively input the edge position of the long film F detected by the sensor into the control device 3, and to control the deflecting operation of the galvanometer scanner 13 by means of the control device 3 by also using the input edge position. Specifically, it suffices for the control device 3 to control the deflecting operation of the galvanometer scanner 13 so that the scanning positions of the laser beam L on the long film F that are determined based on a resultant speed of the scanning speed of the laser beam L by the deflecting operation of the galvanometer scanner 13 and the conveying speed of the long film F and the edge position of the long film F, match the desired cutting shape (desired cutting positions) of the long film F.

Hereunder, an example of results obtained when the productivity of laser processing methods according to the present embodiment (Example), Comparative Examples and a Reference Example were evaluated will be described.

When evaluating the productivity, with respect to each of the laser processing methods, 6 sheets of optical films, each of which is for a smartphone and has an approximately rectangular shape in which the dimensions of the film prior to cutting were 130 mm in the width direction (X-direction) and 70 mm in the longitudinal direction (Y-direction), were cut out per cycle, and the cycle times for cases in which the respective laser processing method were applied were calculated.

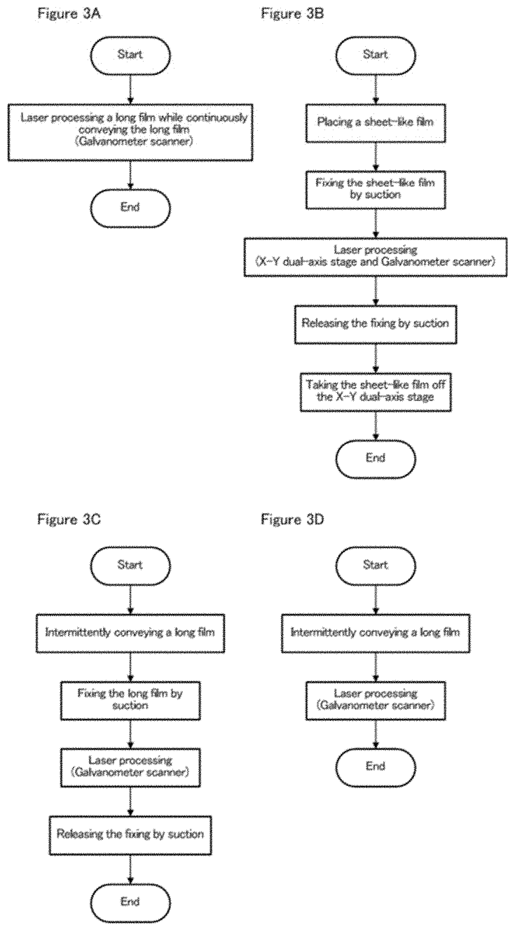

FIG. 3 is views that illustrate outline flows of one cycle of the laser processing methods according to the Example, the Comparative Examples and the Reference Example. FIG. 3(a) illustrates the flow of one cycle of a laser processing method according to the Example. FIG. 3(b) illustrates the flow of one cycle of a laser processing method according to a Comparative Example 1. FIG. 3(c) illustrates the flow of one cycle of a laser processing method according to a Comparative Example 2. FIG. 3(d) illustrates the flow of one cycle of a laser processing method according to the Reference Example.

As illustrated in FIG. 3(a), in the laser processing method according to the Example, as described above, a long film F was cut by irradiating the long film F with the laser beam L while scanning the laser beam L by a deflecting operation of the galvanometer scanner 13 while continuously conveying the long film F between the conveying rolls R1 and R2.

As illustrated in FIG. 3(b), in the laser processing method according to the Comparative Example 1, a sheet-like film was placed on an X-Y dual-axis stage and fixed by suction thereto, and the film was cut by changing the relative position on an X-Y two-dimensional plane of the film with respect to the laser beam L by driving the X-Y dual-axis stage and irradiating the film with the laser beam L while scanning the laser beam L by a deflecting operation of the galvanometer scanner 13 in a similar manner to the Example.

As illustrated in FIG. 3(c), in the laser processing method according to the Comparative Example 2, a long film F was cut by intermittently conveying the long film F between conveying rolls R1 and R2 and, in a similar manner to the method disclosed in Patent Literature 1, placing the long film F in a state in which the long film F was fixed by suction at a position at which the long film F stopped, and irradiating the long film F with the laser beam L while scanning the laser beam L by a deflecting operation of the galvanometer scanner 13.

As illustrated in FIG. 3(d), in the laser processing method according to the Reference Example, although a long film F was intermittently conveyed similarly to the laser processing method according to the Comparative Example 2, fixing of the long film F by suction was not performed at a position at which the long film F was stopped, and the long film F was cut by irradiating the long film F with the laser beam L while scanning the laser beam L by a deflecting operation of the galvanometer scanner 13.

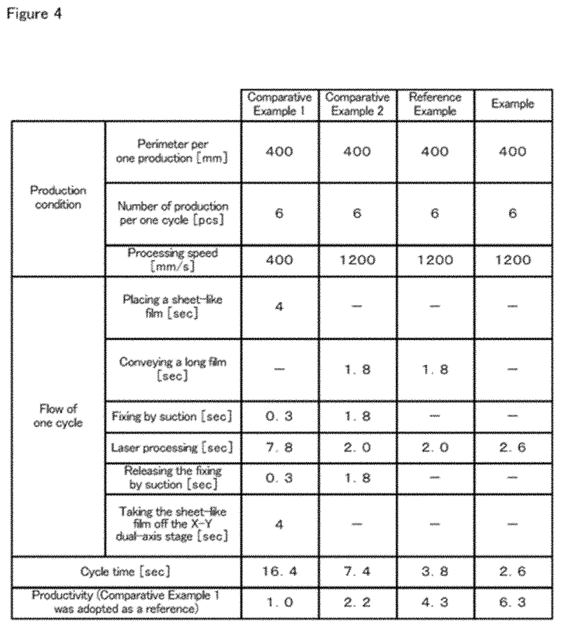

FIG. 4 is a table showing results of evaluating the cycle times of the laser processing methods according to the Example, the Comparative Examples and the Reference Example.

As illustrated in FIG. 4, in the laser processing method according to the Comparative Example 1, time (4 sec in the example shown in FIG. 4) was required to place the sheet-like film at a predetermined position on the X-Y dual-axis stage, and time (4 sec in the example shown in FIG. 4) was required to take the film off the X-Y dual-axis stage to retrieve the film after laser processing. Further, time (0.3 sec in the example shown in FIG. 4) was required to fix the sheet-like film by suction to the X-Y dual-axis stage, and time (0.3 sec in the example shown in FIG. 4) was required to release the fixing by suction of the film. In addition, in the laser processing method according to the Comparative Example 1, because the X-Y dual-axis stage was being driven when scanning the laser beam L, the time required for laser processing (7.8 sec in the example shown in FIG. 4) was longer in comparison to the cases of scanning the laser beam L by only a deflecting operation of the galvanometer scanner 13 (in the Comparative Example 2, the Reference Example, and the Example).

As illustrated in FIG. 4, in the laser processing method according to the Comparative Example 2, because the long film F was conveyed between the conveying rolls R1 and R2, in comparison to a case of using a sheet-like film as in the laser processing method according to the Comparative Example 1, time was not required to place the film on an X-Y dual-axis stage and take the film off therefrom.

However, because intermittent conveyance was used in which conveying and stopping of the long film F were alternately repeated, it took more time to convey the long film F (1.8 sec in the example shown in FIG. 4) in comparison to a case of continuously conveying the long film F without causing the long film F to stop. Further, similarly to the laser processing method according to the Comparative Example 1, time was required to fix the long film F by suction (1.8 sec in the example shown in FIG. 4), and time was also required to release the long film F fixed by suction (1.8 sec in the example shown in FIG. 4).

As illustrated in FIG. 4, in the laser processing method according to the Reference Example, unlike the laser processing method according to the Comparative Example 2, since fixing of the long film F by suction at the stopped position was not performed, time was not required to fix the long film F by suction and time was not required to release fixing by suction of the long film F.

However, similarly to the laser processing method according to the Comparative Example 2, because the long film F was intermittently conveyed, it took more time to convey the long film F (1.8 sec in the example shown in FIG. 4) in comparison to a case of continuously conveying the long film F without stopping.

As illustrated in FIG. 4, in the laser processing method according to the Example, unlike the laser processing method according to the Reference Example, because the laser beam L was scanned by a deflecting operation of the galvanometer scanner 13 while continuously conveying the long film F between the conveying rolls R1 and R2, the conveying time of the long film F was shortened (time necessary for stopping operations and resuming the conveying operation was not required) in comparison to the laser processing method according to the Reference Example.

As illustrated in FIG. 4, when productivity was evaluated based on the cycle times calculated for the Comparative Example 1, the Comparative Example 2, the Reference Example and the Example, it was found that, when the laser processing method according to the Comparative Example 1 was adopted as a reference (productivity=1.0), the productivity of the laser processing method according to the Example was 6.3, indicating that the productivity increased by a large margin.

As described above, according to the laser processing method of the present embodiment, because the long film F is continuously conveyed without being stopped when performing laser processing, the time required to convey the long film F is shortened. Further, no time is required to fix the long film F by suction or to release fixing by suction of the long film F. Therefore, it is possible to increase the productivity of laser processing of the long film F.

### REFERENCE SIGNS LIST

1 Optical Unit
2 Rotary Encoder
3 Control Device
11 Laser Beam Source
12 Optical Element
13 Galvanometer Scanner
100 Laser Processing Apparatus
131 Movable Lens
132 Condenser Lens
133 First Galvanometer Mirror
134 Second Galvanometer Mirror
F Long Film
L Laser Beam

1. A laser processing method for a long film, comprising:
a process of cutting a long film by irradiating the long film with a laser beam while scanning the laser beam by a deflecting operation of a galvanometer scanner and while continuously conveying the long film in a longitudinal direction,
wherein the deflecting operation of the galvanometer scanner is controlled based on a desired cutting shape of the long film set in advance and a conveying speed of the long film.

2. The laser processing method for a long film according to claim 1, wherein:
a conveying speed of the long film is measured, and the deflecting operation of the galvanometer scanner is controlled based on the desired cutting shape of the long film and the measured conveying speed of the long film.
